(19) United States
(12) Patent Application Publication
(10) Pub. No.: US 2005/0019506 A1
(43) Pub. Date: Jan. 27, 2005

(54) Ink jet recording medium and method for producing the same

(75) Inventors: Kazuyuki Koike, Shizuoka-ken (JP); Takashi Kobayashi, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/858,397

(22) Filed: Jun. 2, 2004

(30) Foreign Application Priority Data
Jun. 3, 2003 (JP) 2003-157598
May 13, 2004 (JP) 2004-143696

(51) Int. Cl. B41M 5/00

(52) U.S. Cl. 428/32.24

(57) ABSTRACT

A method for producing an ink jet recording medium, including: coating a first liquid containing a water-soluble resin and a cross-linking agent to form a coating layer on a support; and providing a second liquid containing a metal compound and a basic compound to the coating layer either (1) simultaneously with coating of the first liquid or (2) before the coating layer formed of the first liquid exhibits a decreasing rate of drying during drying of the coating layer such that the coating layer is hardened by cross-linking to form an ink receiving layer on the support.

### CROSS-REFERENCE TO RELATED APPLICATION

This application claims priority under 35USC 119 from Japanese Patent Application Nos. 2003-157598 and 2004-143696, the disclosures of which are incorporated by reference herein.

### BACKGROUND OF THE INVENTION

1. Field of the Invention

The present invention relates to an ink jet recording medium and a method for producing an ink jet recording medium. The ink jet recording medium is suitable for ink jet recording using liquid ink such as aqueous ink and oil-based ink, solid ink which is solid at room temperature and is melted and liquidized for printing, and the like, and is excellent in printing property.

2. Description of the Related Art

Recently, various. information processing systems have been developed along with rapid development in the information industry. Recording methods and devices suitable for these information processing systems have also been developed and variously put to practical use. Among the above-mentioned recording methods, the ink jet recording method can be used to record on many kinds of recording materials, and hardware (a device) therefor is comparatively low-priced, compact, and very quiet. Therefore, the ink jet recording method has been widely used in the office as well as at home.

Further, various mediums for ink jet recording have been developed in recent years along with the achievement of high resolution ink jet printers and the development of hardware (devices), and it has become possible to obtain so-called “photograph-like” high-quality recorded products. In particular, examples of the properties required for the mediums for ink jet recording include (1) quick drying (high ink absorption speed), (2) ink dots having proper and uniform diameters (no bleeding), (3) excellent granularity, (4) high circularity of dots, (5) high color density, (6) high saturation (no dullness), (7) excellent light fastness, gas resistance and water resistance at printed portions, (8) a recording surface having a high degree of whiteness, (9) excellent storability of a recording medium (no yellow discoloration or image bleeding during long term storage), (10) resistance to deformation and excellent dimensional stability (sufficiently small curl), and (11) excellent running properties in hardware. Further, in addition to the above-mentioned properties, glossiness, surface flatness and texture similar to that of a silver salt photograph are required for use as photographic glossy paper used to obtain the photograph-like high-quality recorded product.

As a medium for ink jet recording which satisfies these requirements, a medium obtained by forming a colorant receiving layer on a support by coating liquid containing inorganic fine particles such as fumed silica, a mordant such as a cation polymer, a water-soluble resin such as polyvinyl alcohol (PVA), and a hardening agent for the water-soluble resin (boric acid or the like) (for instance, see Japanese Patent Application Laid-Open (JP-A) No. 2000-211235 (paragraphs 0055-0057)) is known. As another such medium, a medium obtained by forming a colorant receiving layer by coating a liquid including inorganic fine particles such as fumed silica, a metal compound such as a water-soluble metal salt, and a water-soluble resin such as PVA on a support, providing a liquid containing a hardening agent for the water-soluble resin (boric acid or the like) to the coating layer before the coating layer formed is completely dried, and hardening (for instance, see JP-A No. 2003-334742) is known. However, in the former, the printing density of the image is low. In the latter, although the colorant receiving layer formed can be prevented from cracking, the printing density is low, and the stability of the coating liquid is also insufficient.

In addition to the above-mentioned cationic polymer, an inorganic mordant such as a multivalent metal salt is known as a mordant for fixing ink dye. A technique which improves bleeding properties and water resistance during storage after printing without bronzing is disclosed. Specifically, the technique uses inorganic fine particles and a water-soluble resin such as PVA, as well as a compound having a cationic polymer having a quaternary ammonium base and a zirconium or aluminum atom in its molecule, or a compound including a multivalent metal atom in its molecule (for instance, see JP-A Nos. 2002-172850, 2002-192830, and 2002-274013). Bronzing and cracking can be prevented to a certain degree, but sufficient printing density cannot be obtained.

In a system which uses a primary, secondary, tertiary or quaternary amine compound or the like as a mordant, the white background of the recording surface may undergo yellow discoloration over time. JP-A No. 2001-088439 discloses a technique for adjusting the pH of the surface of the ink receiving layer, which receives ink, to 6 to 7 to improve the yellow discoloration. However, there is a problem in that the beading and bronzing cannot be prevented.

To improve the above-mentioned beading, JP-A No. 11-348416 discloses recording paper having cracks in the surface of a transparent porous layer. However, there is a problem in that printing density is low. JP-A No. 2000-071603 discloses a technique which improves beading by including a basic oligomer having a molecular weight of 1000 to 8000 in the ink receiving layer. However, there is a problem in that yellow discoloration is caused.

As described above, a technique for producing an ink jet recording medium which can form a brilliant image by preventing yellow discoloration on the recording surface (non-image portion) while securing sufficient printing density and can prevent beading and bronzing from occurring has not been established.

### SUMMARY OF THE INVENTION

It is an object of the present invention to provide an ink jet recording medium and a method for producing an ink jet recording medium which can form an ink receiving layer in which no cracks or the like occur, and which is strong, excellent in ink absorbability and water resistance, and suppresses yellow discoloration of a recording surface (non-image portion), bronzing and beading (especially, at printed portions with a high density).

In the invention, the term “beading” refers to a phenomenon in that the ink is not sufficiently absorbed to the ink receiving layer at the time of ink jet recording, dye in the ink is partially agglomerated, and density irregularity is caused. The term “bronzing” refers to a phenomenon in that a printed portion in which blue density is high appears reddish brown.

A first aspect of the invention is to provide a method for producing an ink jet recording medium. The method includes: coating a first liquid containing a water-soluble resin and a cross-linking agent to form a coating layer on a support; and providing a second liquid including a metal compound and a basic compound to the coating layer either (1) simultaneously with coating of the first liquid or (2) before the coating layer formed of the first liquid exhibits a decreasing rate of drying during drying of the coating layer such that the coating layer is hardened by cross-linking to form an ink receiving layer on the support.

A second aspect of the invention is to provide an ink jet recording medium produced by the method of the first aspect. A concentration distribution of the metal compound contained in the ink receiving layer is such that a concentration of the metal compound becomes larger towards a direction away from the support in a thickness direction of the ink receiving layer.

The invention can provide an ink jet recording medium and a method for producing an ink jet recording medium which can form a strong ink receiving layer in which no cracks or the like occur. The ink receiving layer of the invention is also excellent in ink absorbability and water resistance, and suppresses yellow discoloration of the recording surface (non-image portion), bronzing and beading (especially, at printed portions with high density).

### DETAILED DESCRIPTION OF THE INVENTION

In the method for producing an ink jet recording medium of the present invention, an ink receiving layer is formed by providing a second liquid containing a metal compound (preferably, a zirconium compound) and a basic compound (preferably, an ammonium salt of weak acid) to the coating layer formed of a first liquid.

Hereinafter, a method for producing an ink jet recording medium of the invention will be described in detail. Through the explanation, an ink jet recording medium of the invention will also be described in detail.

A method for producing an ink jet recording medium of the invention is a method (Wet-On-Wet method (WOW method)), including: coating a first liquid (hereinafter, may be referred to as “coating liquid for an ink receiving layer”) containing a water-soluble resin and a cross-linking agent to form a coating layer on a support; and providing a second liquid (hereinafter, may be referred to as “basic solution”) containing a metal compound and a basic compound to the coating layer either (1) simultaneously with coating of the first liquid or (2) before the coating layer formed by coating the first liquid exhibits a decreasing rate of drying during drying of the coating layer formed of the first liquid. In the coating step, the coating layer is hardened by cross-linking by hardening by cross-linking the coating layer formed on the support to form an ink receiving layer. The ink jet recording medium of the present invention is produced by the above-described method for producing an ink jet recording medium.

In the invention, the coating layer composed of the first liquid is formed beforehand, and the second liquid including a metal compound (preferably, a zirconium compound) and a basic compound (preferably, an ammonium salt of weak acid) is applied to the coating layer whereby an excellent film forming property of sufficiently hardening the layer can be obtained. Since the metal compound (preferably, the zirconium compound; and the other mordant components) exists near the surface of the ink receiving layer, ink, especially dye, is sufficiently mordanted to form a high density image and to improve water resistance of the printed portion. In addition, beading and bronzing can be effectively suppressed. Moreover, since not only a metal compound (preferably, a zirconium compound) but also a basic compound (preferably, an ammonium salt of weak acid) is used in combination, the hard film property and mordant property are improved, and the beading is effectively suppressed compared with the case of non-combination. In other words, it is effective to replace a part of the metal compound by a basic compound such that the amount of the metal compound is not present too much. In addition, yellow discoloration can be effectively suppressed since a primary, secondary, tertiary or quaternary ammonium based mordant is not used.

The ink receiving layer formed by the coating step of the invention and the hardening step has the porous structure, and the ink receiving layer has high ink absorption property. Dots having excellent round can be formed without ink bleeding, and further yellow discoloration during storage, beading and bronzing are effectively suppressed. Therefore, the image having high contrast and high quality can be formed.

As the metal compound to be used in the second liquid, any metal compound that is stable under basic can be used without limitation. Preferable examples of the metal compound include a metal salt, a metal complex compound, an inorganic oligomer and an inorganic polymer. For instance, a zirconium compound, a zinc compound and compounds listed as mordants described below are preferable. A metal complex described in “Kagaku Sosetu (Chemistry Review) No. 32 (1981)” edited by the Chemical Society of Japan, and a transition metal complex containing a transition metal such as ruthenium described in “Coordination Chemistry Review”, Vol. 84, pp. 85-277 (1988) and in Japanese Patent Application Laid-Open (JP-A) No. 2-182701 can be used as the metal complex compound.

Among the above examples, as the metal compound, the zirconium compound and the zinc compound are preferable, and the zirconium compound is particularly preferable. Examples of the zirconium compound include ammonium zirconium carbonate, ammonium zirconium nitrate, potassium zirconium carbonate, ammonium zirconium citrate, zirconyl stearate, zirconyl octyl, zirconyl nitrate, zirconium oxychloride and zirconium hydroxychloride. The ammonium zirconium carbonate is particularly preferable. The second liquid may contain two or more kinds of metal compounds (preferably, including a zirconium compound) in combination.

The metal compound (preferably, the zirconium compound) is contained in the second liquid preferably in an amount of 0.05 to 5% by mass, and more preferably 0.1 to 2% by mass based on the total mass (including a solvent) of the second liquid. The coating layer can be sufficiently hardened by adjusting the content of the metal compound (particularly, the zirconium compound) in the particular range. Further, by this adjustment of the content of the metal compound, the mordant property can be maintained, and sufficient printing density is obtained. Also, no beading is observed, and the deterioration of the working environment due to the increase of density of basic compound such as ammonia is not caused. Two or more kinds of the metal compounds may be used in combination. When a below-described mordant component other than a metal compound is used in combination, the total amount is preferably within the above range. The mordant component may be contained within the range in that the effect of the invention is not ruined.

Next, the basic compound contained in the second liquid will be described.

Examples of the basic compound include an ammonium salt of weak acid, an alkali metal salt of weak acid (for instance, lithium carbonate, sodium carbonate, potassium carbonate, lithium acetate, sodium acetate and potassium acetate), an alkali earth metal salt of weak acid (for instance, magnesium carbonate, barium carbonate, magnesium acetate and barium acetate), hydroxy ammonium, a primary-a tertiary amine (for instance, triethylamine, tripropyleneamine, tributhylamine, trihexylamine, dibutylamine and butylamine), a primary-a tertiary aniline (for instance, diethylaniline, dibutylaniline, ethylaniline and aniline), pyridine which may have a substituent (for instance, 2-amino pyridine, 3-amino pyridine, 4-amino pyridine, 4-(2-hydroxyethyl)-amino pyridine).

Another basic material and/or a salt thereof may be used in combination with the above-described basic compound. Examples of the other basic material include ammonia, primary amines (such as ethyl amine and polyallylamine), secondary amines (such as dimethylamine and triethylamine), and third amines (such as N-ethyl-N-methylbutylamine), the hydroxide of alkali metals and alkaline-earth metals.

Among the above, an ammonium salt of weak acid is particularly preferable. The weak acid is an acid in which pKa is 2 or more in the inorganic acid and the organic acid described in chemical handbook basic chapter II (Maruzen Co., Ltd.) or the like. Examples of the ammonium salt of weak acid include ammonium carbonate, ammonium hydrogencarbonate, ammonium boric acid, ammonium acetate and ammonium carbamate. However, the ammonium salt of weak acid is not limited to these examples. Ammonium carbonate, ammonium hydrogencarbonate and ammonium carbamate are preferable among them; they do not remain in the layer after being dried, and thereby the ink bleeding can be reduced.

Two or more kinds of the basic compound may be used in combination.

The basic compound (particularly, the ammonium salt of weak acid) is contained in the second liquid preferably in an amount of 0.5 to 10% by mass, and more preferably 1 to 5% by mass based on the total mass (including a solvent) of the second liquid. When the content of the basic compound (particularly, the ammonium salt of weak acid) is adjusted in the above-described particular range, sufficient hardening degree can be obtained without increasing the ammonia density too much and deteriorating the working environment.

As a first liquid in the coating step, for instance, a coating liquid for an ink receiving layer which contains the fumed silica, polyvinyl alcohol (PVA), boric acid, a cationic resin, nonionic or an amphoteric surface active agent and a high boiling point organic solvent can be prepared below. Each component which constitutes the first liquid will be described below.

The fumed silica is added to water, and a cationic resin is added further to the resultant mixture. The resultant mixture is then dispersed by a high-pressure homogenizer and a sand mill or the like. Boric acid, PVA solution (for instance, such that the amount of PVA becomes the mass of about ⅓ of the fumed silica) are added to the resultant mixture. In addition, a nonionic or an amphoteric surface active agent and a high boiling point organic solvent are added and stirred, and thereby the first liquid can be prepared. The coating liquid obtained is uniform sol. The coating layer is obtained by coating the coating liquid on the support by the coating method as described below, and the porous ink receiving layer which has the three-dimensional network structure can be formed. At this time, as described above, PVA can be prevented from gelling partially by adding the PVA after the boric acid is added.

Aqueous dispersed liquid having an average particle diameter of 10 to 300 nm can be prepared by grain-refining the first liquid (the coating liquid for the ink receiving layer) using a disperser. Known various dispersers such as a high speed rotating disperser, a medium stirring type disperser (a ball mill and a sand mill or the like), an ultrasonic disperser, a colloid mill disperser, and a high pressure disperser can be used as a disperser which is used for obtaining the water dispersion liquid. However, the medium stirring type disperser, the colloid mill disperser and the high pressure disperser are preferable in view of dispersing efficiently agglomerate-like fine particles formed.

In the invention, the first liquid is preferably an acid solution. The pH of the first liquid is preferably 6.0 or less, more preferably 5.0 or less, and most preferably 4.0 or less. The pH can be adjusted by properly selecting the kind and the amounts added of the cationic resin. An organic acid or an inorganic acid may also be added for adjusting. When the pH of the first liquid is 6.0 or less, the cross-linking reaction of the water-soluble resin due to the cross-linking agent (particularly, boron compound) can be more sufficiently suppressed in the first liquid.

For instance, the first liquid (the coating liquid for an ink receiving layer) in the coating step can be coated by a known coating method using an extrusion die coater, an air doctor coater, a bread coater, a rod coater, a knife coater, a squeeze coater, a reverse roll coater, and a bar coater or the like.

The second liquid (the basic liquid) can be applied in the hardening step after the coating liquid (the first liquid) for the ink receiving layer is coated. The second liquid is preferably applied before the coating layer exhibits a decreasing rate of drying. That is, the coating layer is preferably produced by applying the second liquid while the coating layer exhibits a constant rate of drying after the first liquid is coated.

The second liquid may contain a cross-linking agent and other mordant components if necessary. The hardening of the layer can be accelerated by using the second liquid that is an alkaline solution. The second liquid is preferably adjusted to a pH of 7.1 or more, more preferably a pH of 8.0 or more, and most preferably a pH of 9.0 or more. When the pH is too near an acid side, the cross-linking reaction of the water-soluble polymer included in the first liquid does not performed sufficiently by the cross-linking agent, and thereby bronzing and the defect due to the crack or the like may be caused in the ink receiving layer.

For instance, the second liquid can be prepared by adding a metal compound (e.g., a zirconium compound; for instance, 1 to 5%), a basic compound (e.g., an ammonium carbonate; for instance, 1 to 5%), and, if necessary, para-toluene sulfonate (for instance, 0.5 to 3%) to the ion-exchange water, and by stirring the resultant mixture sufficiently. The term “%” in each composition refers to solid mass.

Water, an organic solvent or the mixed solvent thereof can be used as the solvent used for preparing each liquid. Examples of organic solvents which can be used for coating include alcohols such as methanol, ethanol, n-propanol, i-propanol and methoxy propanol, ketones such as acetone and methyl ethyl ketone, tetrahydrofuran, acetonitrile, ethyl acetate, and toluene.

“Before the coating layer exhibits a decreasing rate of drying” in the hardening step usually refers to the period of a few minutes immediately after coating the coating liquid for the ink receiving layer. During the period, the coating layer exhibits a constant rate of drying, during which the contained amount of the solvent (dispersing medium) in the coating layer decreases in proportion to time. For instance, the time exhibiting the “constant rate of drying” is described in Chemical Engineering Handbook (pp. 707-712, Maruzen Co., Ltd., Oct. 25, 1980).

As described above, after coating the first liquid, the coating layer is dried until the coating layer formed of the first liquid exhibits a decreasing rate of drying. In general, the coating layer is dried for 0.5 to 10 minutes (preferably, for 0.5 to 5 minutes) at 40 to 180° C. (preferably, at 50 to 120° C.). The above-mentioned range is usually suitable though the drying time naturally depends on the coating amount.

Examples of methods for applying before the coating layer exhibits a decreasing rate of drying include (1) a method for coating the second liquid further on the coating layer, (2) a method for spraying by a spray or the like, and (3) a method for soaking a support on which the coating layer is formed in the second liquid.

In the method (1), for instance, a known coating method such as a curtain flow coater, an extrusion die coater, an air doctor coater, a bread coater, a rod coater, a knife coater, a squeeze coater, a reverse roll coater, and a bar coater can be used as a coating method for coating the second liquid. It is preferable to use a method in which a coater does not directly contact with the coating layer which has already been formed such as the extrusion die coater, the curtain flow coater and the bar coater.

After the second liquid is applied, the coating layer is heated in general at 40 to 180° C. for 0.5 to 30 minutes, is dried and is hardened. The coating layer is preferably heated at 40 to 150° C. for 1 to 20 minutes.

The coating step and the hardening step can be performed at the same time. That is, the second liquid (basic solution) is suitably applied at the same time of coating the first liquid (coating liquid for the ink receiving layer). In this case, the first liquid and the second liquid are applied simultaneously on the support (laminating layer coating) such that the first liquid is contact with the support, hardened and dried. Therefore, the ink receiving layer can be formed.

For instance, the simultaneous coating (laminating layer coating) can be performed by the coating method which uses the extrusion die coater and the curtain flow coater. The coating layer formed is then dried. In this case, in general, the coating layer is dried by heating at 15 to 150° C. for 0.5 to 10 minutes, and more preferably at 40 to 100° C. for 0.5 to 5 minutes.

When the simultaneous coating (laminating layer coating) is performed by the extrusion die coater, two kinds of coating liquids exhaled simultaneously is laminated and formed near the discharge port of the extrusion die coater, that is, before the liquids move on the support, and in the state, the layer is laminated and coated on the support. When two coating liquid laminated and coated before coating moving to the support, the cross-linking reaction is easily caused in the interface of two liquids. Two liquids discharged are mixed and easy to have high viscosity near the discharge port of the extrusion die coater, and thereby the hindrance may be caused in the coating operation. Therefore, when coating simultaneously as described above, a barrier layer liquid (an interlayer liquid) is preferably interposed between the first liquid and the second liquid to coating in threefold simultaneously.

The barrier layer liquid can be selected without being limited. Examples of the barrier layer liquids include solution which contains a small amount of the water-soluble resin and water. The water-soluble resin is used for viscosity improver or the like in consideration of coating. Examples of the water-soluble resins include polymers such as a cellulose system resin (for instance, hydroxypropyl methylcellulose, methyl cellulose and hydroxy ethyl methyl cellulose or the like), polyvinylpyrrolidone, and gelatin. The barrier layer liquid can contain a mordant.

The surface flatness, glossiness degree, transparency and coating film strength of the ink receiving layer can be improved by performing a calendar treatment between roll nips under heating and pressurizing by using a super-calendar and a gross calendar or the like after forming the ink receiving layer on the support. However, it is necessary to set the condition with few reduction of the void ratio since the calendar treatment may causes the reduction of the void ratio (that is, since the ink absorption performance may be reduced).

The temperature of the roll is preferably 30 to 150° C., and more preferably 40 to 100° C. when performing the calendar treatment. The line pressure between the rolls is preferably 50 to 400 kg/cm, and more preferably 100 to 200 kg/cm when performing the calendar treatment.

It is necessary to determine the layer thickness of the ink receiving layer in relation to the void ratio in the layer since the layer thickness of the ink receiving layer should have the absorption volume for absorbing all droplet in case of the ink jet recording. When the amount of ink is 8 nL/mm² and the void ratio is 60%, the layer thickness of about 15 μm or more is needed. Therefore, the layer thickness of the ink receiving layer is preferably 10 to 50 μm in case of the ink jet recording.

The pore size of the ink receiving layer has preferably a median diameter of 0.005 to 0.030 μm, and more preferably 0.01 to 0.025 μm. The void ratio and the pore median diameter can be measured by using a mercury porosimeter (trade name: boresizer 9320-PC2, manufactured by Shimadzu Corporation).

The ink receiving layer is preferably excellent in transparency. When the ink receiving layer is formed on a transparent film, the haze value of the ink receiving layer is preferably 30% or less, and more preferably 20% or less to get an idea. The haze value can be measured with a haze meter (trade name: HGM-2DP, manufactured by Suga Test Instrument Co., Ltd.).

Hereinafter, each component which constitutes the first liquid and the second liquid and a support will be described in detail.

(Inorganic Particles) The first liquid may preferably include inorganic particles. By incorporating inorganic particles in the first liquid, the ink receiving layer would have a porous structure and the ink absorbing property thereof would be effectively improved. Examples of inorganic particles include silica particles such as fumed silica and water-containing silica particles, colloidal silica, titanium dioxide, barium sulfate, calcium silicate, zeolite, kaolinyte, halloysite, mica, talc, calcium carbonate, magnesium carbonate, calcium sulfate, boehmite and pseudo boehmite. These can be used singly or in combination. The inorganic particles are preferably dispersed by a cationic resin.

Especially, the fumed silica is preferably used as the inorganic particles, and the fumed silica and the other inorganic particles can be used in combination. When the fumed silica and the other inorganic particles are used in combination, the amount of the fumed silica which occupy in the total mass of the inorganic particles is preferably 90% by mass or more, and more preferably 95% by mass or more.

The silica particles are usually divided roughly into wet process particles and dry process particles (vapor phase process). In the wet process, active silica is produced by acid decomposing of silicate salt, and water-containing silica is obtained by polymerizing the active silica moderately, cohering and submerging. On the other hand, in a vapor phase method, a flame hydrolysis method and an arc method are main current. In the flame hydrolysis method, anhydrous silica is obtained by a high temperature vapor phase hydrolysis of hydrogen-silicon. In the arc method, silicon and coke are heated, reduced and vaporized in an electric furnace by arc, and the anhydrous silica is obtained by oxidizing the resultant mixture by air. The “fumed silica” refers to anhydrous silica particles obtained by the vapor phase method.

Since the fumed silica have the density and the empty hole of the silanol group of the surface which are different from that of the water-containing silica, the fumed silica shows different property, and is suitable for forming a three-dimensional structure having high void ratio. The reason is not clear. It is considered that the density of silanol group on the surface of the fine particle is 5 to 8 pieces/nm² in the water-containing silica and thereby the silica particles aggregate easily. On the other hand, it is considered that the density of silanol group on the surface of the fine particle is 2 to 3 pieces/nm² and the silica particles flocculate, and thereby the void ratio is high.

Since the fumed silica has a large specific surface area especially, the silica has high ink absorption property and high holding efficiency. Since the silica has low refractive index, the transparency can be imparted to the ink receiving layer when dispersing to appropriate particle diameter, and high color density and excellent color can be obtained. It is important that the receiving layer is transparent in view of obtaining high color density and excellent color glossiness even when applying to photographic glossy paper or the like.

The average primary particle diameter of the fumed silica is preferably 20 nm or less, more preferably 10 nm or less, and most preferably 3 to 10 nm. The particles of the fumed silica adhere easily to each other by the hydrogen bonding due to the silanol group. When the average primary particle diameter is 20 nm or less, the structure having large void ratio can be formed. Therefore, the ink absorption property can be effectively improved, and the transparency and surface glossiness of the ink receiving layer can be improved. The fumed silica may be used in the state of primary order particle, and in the state of secondary particle.

The fumed silica is preferably used in a dispersed state. The fumed silica can be dispersed by using a cationic resin as a dispersing agent (a cohesion preventing agent), and can be used as a fumed silica dispersion. The cationic resin is not particularly limited. However, a cationic polymer such as a primary, secondary or tertiary amino group and the salt thereof, and a quaternary ammonium base are preferable, and the examples thereof include the examples of other mordant components described below. A silane coupling agent is also preferably used as a dispersing agent. Water soluble type or water emulsion type or the like can be preferably used. Examples include dicyan diamide-formalin condensation polymer such as dicyan based cationic resin, dicyan amide-diethylene triamine condensation polymer such as polyamine based cationic resin, epichlorhydrin-dimethylamine addition polymer, dimethyl diaryl ammonium chloride-SO₂ copolymer, diaryl amine salt-SO₂ copolymer, dimethyl diaryl ammonium chloridepolymer, polymer of aryl amine salt, dialkyl amino ethyl (meth)acrylate quaternary salt polymer, poly cationic based cationic resin of acryl amide-diaryl amine salt copolymer.

Especially, it is preferable that the fumed silica has a specific surface area of 200 m²/g or more as measured according to the BET method. The porous structure is obtained by containing the fumed silica, and thereby the ink absorption performance can be improved. The quick-drying performance and the ink bleeding properties can be improved by using the silica particles having a specific surface area of 200 m²/g or more, and thereby the image quality and the printing density can be improved.

Herein, the BET method is one of methods for measuring the surface area of particle by a vapor phase adsorption method, and a method for obtaining a total surface area of the sample of 1 g, that is, a specific surface area from an adsorption isotherm. Nitrogen gas is usually used an adsorption gas, and the amount of adsorption is generally measured from the change in the pressure or volume of an adsorbed gas. There is a Brunauer Emmett and Teller (BET) equation which shows the isotherm of multimolecular adsorption. The amount of adsorption is obtained based on the equation, and the surface area is obtained by multiplying the amount of adsorption by the area that one adsorption molecule occupies on the surface.

(Water-soluble Resin)

The first liquid includes a water-soluble resin. Examples of the water-soluble resins include polyvinyl alcohol (PVA), polyvinyl acetal, cellulose based resin [methyl cellulose (MC), ethyl cellulose (EC), hydroxy ethyl cellulose (HEC), and carboxymethylcellulose (CMC)], chitins, chitosans, starch; polyethylene oxide (PEO) which is a resin having ether bonding, polypropylene oxide (PPO), polyethylene glycol (PEG), polyvinyl ether (PVE); polyacrylamide (PAAM) which is a resin having an amid group or amide bonding, poly vinylpyrrolidone (PVP), polyacrylate which has a carboxyl group as a dissociated group, a maleic acid resin, alginate, and gelatins. These can be also used singly or in combination.

Polyvinyl alcohol is preferable among them, and polyvinyl alcohol and the other water-soluble resin can be used in combination. When polyvinyl alcohol and the other water-soluble resin are used in combination, the amount of the polyvinyl alcohol which occupies in the total mass of the water-soluble resin is preferably 90% by mass or more, and more preferably 95% by mass or more.

The polyvinyl alcohol includes cation modified polyvinyl alcohol, anion modified polyvinyl alcohol, silanol modified polyvinyl alcohol, and other polyvinyl alcohol derivatives in addition to polyvinyl alcohol (PVA). The polyvinyl alcohol can be used singly or in combination.

The polyvinyl alcohol (PVA) has the hydroxyl group in the structure unit. The hydroxyl group and the silanol group formed on the surface of silica particles forms the hydrogen bonding, and the three-dimensional network structure for making the secondary particles of the silica particles a unit chain is easily formed. The ink receiving layer of the porous structure having high void ratio can be formed by forming the three-dimensional network structure.

Thus, the ink receiving layer having porous structure rapidly absorbs ink by capillary phenomenon at the time of the ink jet recording, and can form excellent round dots without ink bleeding.

The content of the water-soluble resin (particularly, polyviny alcohol) is preferably 9 to 40% by mass, and more preferably 12 to 33% by mass based on the total solid mass of the layer when the ink receiving layer is formed in view of preventing the reduction of the film strength due to the excessive few amount and the crack at drying, and in view of preventing ink absorption property from reducing by reducing the void ratio due to the excessive much amount.

The number average degree of polymerization of the polyvinyl alcohol (PVA) is preferably 1800 or more, and 2000 or more in view of crack prevention. PVA of the saponification degree 88% or more is preferable, and PVA of the saponification degree of 95% or more is particularly preferable in view of the viscosity of the transparency and the coating liquid for forming the ink receiving layer.

Content Ratio of Inorganic Particles and Water-soluble Resin

The content ratio [PB ratio (i:p); the mass of the inorganic particles to 1 part by mass of the water-soluble resin] of all inorganic particles (i) and all water-soluble resins (p) influences the layer structure when forming the layer. That is, the increase in PB ratio causes the increase in the void ratio, the pore volume, and the surface area (per unit mass). The PB ratio is preferably 1.5:1 to 10:1 in view of preventing the reduction of film strength caused by the increase of the PB ratio and the crack at the time of drying, and preventing the reduction of the ink absorption property by the reduction of the void ratio caused by the decrease of the PB ratio.

Since an ink jet recording medium is stressed when the ink jet recording medium passes the transportation system of an ink jet printer, the ink receiving layer should have sufficient film strength. The ink receiving layer should have sufficient film strength to prevent the crack and peeling of the ink receiving layer when cutting the ink jet recording medium in a sheet shape. Therefore, the PB ratio is preferably 5:1 or less, and more preferably 2:1 or more in view of securing the high-speed ink absorption property in the ink jet printer.

For instance, a coating liquid in which the fumed silica having average primary particle diameter of 20 nm or less and the water-soluble resin of PB ratio 2:1 to 5:1 are completely dispersed in an aqueous solution is coated on the support. When the coating layer is dried, the three-dimensional network structure which makes the secondary particle of the silica particles a chain unit is formed. Therefore, a translucent porous membrane can be easily formed in which the average pore size is 30 nm or less; the void ratio is 50 to 80%; the pore ratio volume is 0.5 ml/g or more; specific surface area is 100 m²/g or more.

(Cross-linking Agent)

The cross-linking agent may be contained in the first liquid, and may be also contained in the second liquid. The cross-linking agent can cross-link the water-soluble resin, and the inclusion of the cross-linking agent can form the porous layer hardened by the cross-linking reaction of the cross-linking agent and the water-soluble resin.

The boron compound is preferable for the water-soluble resin, especially polyvinyl alcohol resin. Examples of the boron compound include borax, boric acid, boric acid salt (for instance, orthoboric acid salt, InBO₃, ScBO₃, YBO₃, LaBO₃, Mg₃(BO₃)₂, CO₃(BO₃)₂, diboric acid salt (for instance, Mg₂B₂O₅, CO₂B₂O₅), meth boric acid salt (for instance, LiBO₂, Ca(BO₂)₂, NaBO₂, KBO₂), tetraboric acid salt for instance, Na₂B₄O₇.10H₂O) and pentaboric acid salt (for instance, KB₅O₈.4H₂O, Ca₂B₆O₁₁.7H₂O, and CsB₅O₅). The borax, the boric acid, and the boric acid salt are preferable among them with a view to enabling the prompt cross-linking reaction, and especially the boric acid is preferable.

The following compounds can be used in addition to the boron compound. Examples include aldehyde compounds such as formaldehyde, glyoxal and glutalaldehyde; ketone compounds such as diacetyl and cyclopentanedione; activated halogen compounds such as bis (2-chloroethylurea)-2-hydroxy 4,6-dichloro-1,3,5-triazine, and 2,4-dichloro-6-S-triazine sodium salt; activated vinyl compounds such as divinyl sulfonic acid, 1,3-vinylsulfonyl-2-propanol, N, N′-ethylene bis(vinylsulfonyl acetamido), 1,3,5-acryloyl-hexahydro-S-triazine; N-methylol compound such as dimethylol urea and methyloldimethylhydantoin; melamine resin (for instance, methylol melamine and alkylated methylol melamine); epoxy resin; isocyanate compounds such as 1,6-hexamethylene diisocyanate; aziridine compounds described in U.S. Pat. Nos. 3,017,280 and 2,983,611; carboxyimide compounds described in U.S. Pat. No. 3,100,704; Epoxy system compound such as glycerol triglycidyl ether; ethyleneimino compounds such as 1,6-hexamethylene-N, N′-bis ethylene urea; alkylated carboxy aldehyde compounds such as mucochlor acid and mucophenoxychlor acid; dioxane compounds such as 2,3-dihydroxy dioxane; metal-containing compounds such as titanium lactate, aluminum sulfate, chrome alum, potassium alum, zirconyl acetate and chrome acetate, polyamine compounds such as tetraethylenepentamine, hydrazide compounds such as adipic dihydrazide, and low molecule or polymer or the like which contains oxazollin groups of two or more. The cross-linking agent may be used singly or in combination.

The cross-linking agent may be added to the coating liquid for the ink receiving layer and/or the coating liquid for forming the adjacent layer of the ink receiving layer when the coating liquid for the ink receiving layer is coated. The cross-linking agent can be supplied to the ink receiving layer by coating the coating liquid for the ink receiving layer on the support on which the coating liquid including the cross-linking agent beforehand, or by overcoating the second liquid (for instance, a cross-linking agent solution) after coating the coating liquid for the ink receiving layer which contains the cross-linking agent or contains no cross-linking agent and drying.

For instance, the cross-linking agent may be provided in the following manner. Here, boron compound will be used as an example. When the ink receiving layer is formed by coating a coating liquid (first liquid) for an ink receiving layer, hardening by cross-linking, the layer is hardened by cross-linking by providing a second liquid containing (1) simultaneously with coating of the first liquid or (2) before the coating layer formed by coating the first liquid exhibits a decreasing rate of drying during drying of the coating layer formed of the first liquid. The boron compound as a cross-linking agent may be contained either in the first liquid or in the second liquid, and may be contained in both liquids. When the ink receiving layer is constituted in two or more layers, the coating liquid of two or more can be coated over each other, and the second liquid may be applied on the formed multiple layers.

The amount of the cross-linking agent to be used is preferably 1 to 50% by mass to the mass of the water-soluble resin, and more preferably 5 to 40% by mass.

The ink jet recording medium of the invention is produced by the method for producing the ink jet recording medium of the invention, as described above, the ink jet recording medium including at least an ink receiving layer formed on a support. The ink receiving layer contains a metal compound (preferably a zirconium compound), a basic compound (preferably, an ammonium salt of weak acid; the basic compound may not remain in the layer), a water-soluble resin and a cross-linking agent (and further, preferably, inorganic particles and/or a surfactant). The ink receiving layer may further contain a mordant component other than the metal compound and other components if necessary.

It is preferable that the above metal compound having inhomogeneous concentration distribution is contained in the ink receiving layer formed on the support, and particularly, the concentration distribution of the metal compound contained in an ink receiving layer is such that a concentration of the metal compound becomes larger towards a direction away from the support in the thickness direction of the ink receiving layer. In this case, the metal compound (preferably, the zirconium compound) is present more near the surface away from the support of the ink receiving layer, and thereby the effect of the invention can be more effectively exhibited. Specifically, it is preferable that the ink receiving layer has the concentration distribution satisfying the following formula.
0.8<C¹/C²<1.0

In the formula, C¹ represents a relative concentration in a support-side half of the ink receiving layer, which is one half obtained by bisecting the ink receiving layer along a section parallel to the support, and C² represents a relative concentration in a non-support-side half of the ink receiving layer, which is the other half obtained by bisecting the ink receiving layer. The relative concentration is the concentration of the metal compound with respect to a prescribed value to be desired.

In the invention, since the coating layer contains the metal compound such that bias exists between C¹ and C² so as to satisfy the above formula, that is, bias exists in which the concentration distribution is not so much different between a support-side half obtained by bisecting and a non-support-side half away from the support, no dye is aggregated on the surface of the ink receiving layer. Therefore it is particularly effective in view of bronzing. In other words, when C¹/C² in the above formula is 0.8 or less, beading and bronzing may take place, and when C¹/C² is 1.0 or more, the printing density may decrease.

The relative concentrations C¹ and C² can be determined by measuring the section bisected using TOF-SIMS which is commercially available.

Support

A transparent support made of transparent material such as plastic, and opaque support composed of an opaque material such as paper can be used as a support which can be used for the invention. Especially, a transparent support or an opaque support having high glossiness is preferably used to make the best use of the transparency of the ink receiving layer. Read-only optical disks such as CD-ROM and DVD-ROM, recordable optical disks such as CD-R and DVD-R, and rewritten optical disks can be used as a support, and the ink receiving layer can be formed on both sides of a label.

The Material which is transparent and can endure radiant heat when used on an OHP and a backlight display is preferable as materials which can be used for the transparent support. Examples of the materials include polyesters such as polyethylene terephthalate (PET); polysulfone, polyphenylene oxide, polyimide, polycarbonate and polyamide. The polyesters are preferable among them, and especially, the polyethylene terephthalate is preferable. The thickness of the transparent support is not particularly limited. However, the thickness of 50 to 200 μm is preferable in view of easy handling.

An opaque support having high glossiness whose the surface on which the ink receiving layer is formed has a glossiness degree of 40% or more is preferable. The glossiness degree is a value determined according to the method described in JIS P-8142 (paper and 75 degree method for examining specular glossiness degree of a hardboard). Examples of the supports include the following supports.

Examples include paper supports having high glossiness such as art paper, coat paper, cast coat paper and baryta paper used for a support for a silver salt photography or the like; polyesters such as polyethylene terephthalate (PET, cellulose esters such as nitrocellulose, cellulose acetate and cellulose acetate butilate, opaque high glossiness films which are constituted by containing white pigment or the like in plastic films such as polysulfone, polyphenylene oxide, polyimide, polycarbonate and polyamide (a surface calendar treatment may be performed); or, the supports in which the coating layer made of polyolefin which contains or does not contain the white pigment was formed on the surface of a high glossiness film which contains the various paper support, the transparent support or the white pigment or the like. Also, a white pigment-containing foam polyester film (for instance, a foam PET which contains the polyolefin fine particles, and contains voids formed by drawing) is preferable.

The thickness of the opaque support is not particularly limited. However, the thickness of 50 to 300 μm is preferable in view of handling.

One treated by a corona discharge treatment, a glow discharge treatment, a flame treatment and a ultraviolet radiation treatment or the like may be used for the surface of the support so as to improve wettability and adhesion property.

Next, base paper used for the paper support will be described in detail. The base paper is mainly made of wood pulp, and is made by using a synthetic pulp such as polypropylene in addition to the wood pulp if necessary, or a synthetic fiber such as nylon and polyester. LBKP, LBSP, NBKP, NBSP, LDP, NDP, LUKP and NUKP can be used as the wood pulp. It is preferable to use more LBKP, NBSP, LBSP, NDP and LDP which contain a lot of short fibers. The ratio of LBSP and/or LDP is preferable in the range between 10% by mass and 70% by mass. A chemical pulp with few impurities (sulfate pulp and sulfite pulp) is preferably used as the pulp, and a pulp in which whiteness is improved by bleaching, is useful.

Sizing agents such as higher fatty acid and alkyl ketene dimer, white pigments such as calcium carbonate, talc and titanium oxide, paper reinforcing agents such as starch, polyacrylamide and polyvinyl alcohol, fluorescent whitening agents, water retention agents such as polyethylene glycols, dispersing agents, and softening agents such as a quaternary ammonium can be properly added to the base paper.

The filtered water degree of pulp used for papermaking is preferably 200 to 500 ml in the regulation of CSF. The sum of 24 mesh remainder and the % by mass of 42 mesh remainder is preferably 30 to 70% in the regulation of JIS P-8207. The % by mass of 4 mesh remainder is preferably 20% by mass. The basic weight of the base paper is preferably 30 to 250 g, and more preferably 50 to 200 g. The thickness of the base paper is preferably 40 to 250 μm. High flatness can be imparted to the base paper by calendar treatment at the making paper step or after making paper. The density of the base paper is generally 0.7 to 1.2 g/m² (JIS P-8118). In addition, the strength degree of the base paper is preferably 20 to 200 g in the condition provided in JIS P-8143.

A surface size agent may be coated on the surface of the base paper, and a size agent same as the size which can be added to the base paper can be used as the surface size agent. It is preferable that the pH of the base paper is 5 to 9 when measured by a hot water extraction method provided by JIS P-8113.

In general, the both surfaces of the base paper can be covered with polyethylene. Examples of polyethylenes include polyethylene (LDPE) having low density and/or, and polyethylene (HDPE) having high density. Other LLDPE and the polypropylene or the like can be also used.

Especially, in the polyethylene layer on the side on which the ink receiving layer is formed, it is preferable that rutile type or anatase type titanium oxide, a fluorescent whitening agent and a ultramarine blue pigment are added to polyethylene, and thereby the opaque degree, the whiteness and the color are improved so as to be performed widely in a printing paper for photograph. Herein, the content of titanium oxide is preferably about 3 to 20% by mass, and more preferably 4 to 13% by mass to polyethylene. The thickness of the polyethylene layer is not limited to a particular thickness, and more preferably 10 to 50 μm. Further, a undercoat layer can be formed to give adhesion with the ink receiving layer on the polyethylene layer. Water polyester, gelatin, and PVA are preferably used as the undercoat layer. The thickness of the undercoat layer is preferably 0.01 to 5 μm.

A polyethylene coating paper can be used as a glossy paper. Also, the paper in which the mat surface and the matte surface obtained in usual photograph printing paper is formed by performing so-called typing treatment when polyethylene is coated on the surface of the base paper by melting and extruding can be used.

Next, other mordant components and other components such as a surfactant will be described in detail.

Other Mordant Components

In the invention, in addition to the above-described zirconium compound, the other mordant components can be contained for further improving image bleeding properties during storage and water resistance. Examples of the other mordant components include an organic mordant such as a cationic polymer (a cationic mordant) and an inorganic mordant such as a water-soluble metal compound. A cationic mordant is preferably a polymer mordant having a primary, secondary or tertiary amino group, or a quaternary ammonium group as a cationic functional group. A cationic non-polymer mordant can be also used.

The polymer mordant is preferably a homopolymer of a monomer (mordant monomer) having a primary, secondary or tertiary amino group and its salt, or a quaternary ammonium group, a copolymer or a condensation polymer of a mordant monomer and the other monomer (non-mordant monomer). The polymer mordants can be used in the form of a water-soluble polymer or water dispersible latex particles.

Examples of the mordant monomers include trimethyl-p-vinyl benzyl ammonium chloride, trimethyl-m-vinyl benzyl ammonium chloride, triethyl-p-vinyl benzyl ammonium chloride, triethyl-m-vinyl benzyl ammonium chloride, N,N-dimethyl-N-ethyl-N-p-vinyl benzyl ammonium chloride, N,N-diethyl-N-methyl-N-P-vinyl benzyl ammonium chloride, N,N-dimethy-N-n-propyl-N-p-vinyl benzyl ammonium chloride, N,N-dimethyl-N-n-octyl-N-p-vinyl benzyl ammonium chloride, N,N-dimethyl-N-benzyl-N-p-vinyl benzyl ammonium chloride, N,N-diethyl-N-benzyl-N-p-vinyl benzyl ammonium chloride, N,N-dimethyl-N-(4-methyl) benzyl-N-p-vinyl benzyl ammonium chloride, N,N-dimethyl-N-phenyl-N-p-vinyl benzyl ammonium chloride;
trimethyl-p-vinyl benzyl ammonium bromide, trimethyl-m-vinyl benzyl ammonium bromide, trimethyl p-vinyl benzyl ammonium sulfonate, trimethyl-m-vinyl benzyl ammonium sulfonate, trimethyl-p-vinyl benzyl ammonium acetate, trimethyl-m-vinyl benzyl ammonium acetate, N,N,N-triethyl-N-2-(4-vinylphenyl) ethyl ammonium chloride, N,N,N-triethyl-N-2-(3-vinylphenyl)ethyl ammonium chloride, N,N-diethyl-N-methyl-N-2-(4-vinylphenyl)ethyl ammonium chloride, N,N-diethyl-N-methyl-N-2-(4-vinylphenyl) ethyl ammonium acetate;
N, N-dimethyl aminoethyl (meth)acrylate, N,N-diethyl aminoethyl (meth)acrylate, N,N-dimethyl aminopropyl (meth)acrylate, N,N-diethyl aminopropyl (meth)acrylate, N,N-dimethyl aminoethyl (meth)acrylamide, N,N-diethyl aminoethyl (meth)acrylamide, N,N-dimethyl amino propyl (meth)acrylamide, methyl chloride of N,N-diethyl amino propyl (meth)acrylamide, ethyl chloride, methylbromide, ethylbromide, quaternized body due to methyliodide or ethyliodide, or a sulfonate, an alkyl sulfonate, an acetate or an alkyl carboxylate or the like which substitute the anions.

Examples of the compounds include monomethyl diallyl ammonium chloride, trimethyl-2-(methacryloyloxy) ethyl ammonium chloride, triethyl-2-(methacryloyloxy) ethyl ammonium chloride, trimethyl-2-(acryloyloxy) ethyl ammonium chloride, triethyl-2-(acryloyloxy) ethyl ammonium chloride, trimethyl-3-(methacryloyloxy) propyl ammonium chloride, triethyl-3-(methacryloyloxy) propyl ammonium chloride, trimethyl-2-(methacryloylamino) ethyl ammonium chloride, triethyl-2-(methacryloyamino) ethyl ammonium chloride, trimethyl-2-(acryloylamino) ethyl ammonium chloride, triethyl-2-(acryloylamino) ethyl ammonium chloride, trimethyl-3-(methacryloylamino) propyl ammonium chloride, triethyl-3-(methacryloylamino) propyl ammonium chloride, trimethyl 3-(acryloylamino) propyl ammonium chloride, triethyl-3-(acryloylamino) propyl ammonium chloride;
N,N-dimethyl-N-ethyl-2-(methacryloyloxy) ethyl ammonium chloride, N,N-diethyl-N-methyl-2-(methacryloyloxy) ethyl ammonium chloride, N,N-dimethyl-N-methyl-3-(acryloylamino) propyl ammonium chloride, trimethyl-2-(methacryloyloxy) ethyl ammonium bromide, trimethyl-3-(acryloylamino) propyl ammonium bromide, trimethyl-2-(methacryloyloxy) ethyl ammonium sulfonate, trimethyl-3-(acryloylamino) propyl ammonium acetate. Examples of the other monomers capable of being copolymerized include N-vinyl imidazole and N-vinyl-2-methylimidazole. The vinyl amine unit can be obtained by the hydrolysis after polymerized by using the polymerization unit of N-vinyl acetamide and N-vinyl formamide or the like, and its salt can be also used.

The non-mordant monomer does not contain a primary, secondary or tertiary amino group and its salt, or the basic or the cationic part of a quaternary ammonium group or the like. The non-mordant monomer refers to a monomer that does not interact with dye contained in ink jet ink, or a monomer in which the interaction is substantially small. Examples of the non-mordant monomers include alkyl (meth)acrylate ester; cycloalkyl (meth)acrylate ester such as cyclohexyl (meth)acrylate; ariel (meth)acrylate ester such as phenyl (meth)acrylate; aralkyl ester such as benzil (meth)acrylate; aromatic vinyls such as styrene, vinyl toluene and α-methyl styrene; vinylesters such as vinyl acetate, vinyl propionate and vinyl versatate; aryl esters such as allyl acetate; a halogen-containing monomer such as vinylidene chloride and vinyl chloride; vinyl cyanide such as (meth)acrylonitrile; olefins such as ethylene and propylene.

The alkyl (meth)acrylate ester having 1 to 18 carbon atoms in the alkyl part is preferable. Examples of alkyl (meth)acrylate esters include methyl (meth)acrylate, ethyl (meth)acrylate, propyl (meth)acrylate, isopropyl (meth)acrylate, n-butyl (meth)acrylate, isobutyl (meth)acrylate, t-butyl (meth)acrylate, hexyl (meth)acrylate, octyl (meth)acrylate, 2-ethyl hexyl (meth)acrylate, lauryl (meth)acrylate and stearyl (meth)acrylate. Methyl acrylate, ethyl acrylate, methyl methacrylate, ethyl methacrylate and hydroxy ethyl methacrylate are preferable among them. The non-mordant monomers can be also used singly or in combination.

Further, preferable examples of the polymer mordants include polydiallyldimethyl ammonium chloride, polymethacryloyloxyethyl-β-hydroxy ethyl dimethyl ammonium chloride, polyethylenimine, polyallylamine and the modified body, polyallylamine hydrochloride, a polyamide-polyamine resin, cationized starch, dicyandiamide formalin condensate, dimethyl-2-hydroxy propyl ammonium salt polymer, polyamidine, polyvinyl amine, and a cationic polyurethane resin described in JP-A No. 10-86505.

The polyallylamine modified body is obtained by adding 2 to-50 mol % of acryl nitrile, chloromethylstyrene, TEMPO, epoxy hexane, and sorbic acid or the like to polyacrylamine. The polyallylamine modified body obtained by adding 5 to 10 mol % of acryl nitrile, chloromethylstyrene, TEMPO to polyacrylamine is preferable. Especially, the polyallylamine modified body obtained by adding 5 to 10 mol % of TEMPO to polyacrylamine is preferable in view of showing ozone discoloring prevention effect.

The mordant has preferably a weight average molecular weight of 2,000 to 300,000. The molecular weight which is in the above-mentioned range can improve water resistance and bleeding properties during storage.

Also, an inorganic mordant can be employed as the other mordants. Examples of the inorganic mordants include multivalent water-soluble metal salts and hydrophobic metal salt compounds. Examples include a metal salt or a complex selected from magnesium, aluminum, calcium, scandium, titanium, vanadiucm, manganese, iron, nickel, copper, zinc, gallium, germanium, strontium, yttrium, molybdenum, indium, barium, lanthanum, cerium, praseodymium, neodymium, samarium, europium, gadolinium, dysprosium, erbium, ytterbium, hafnium, tungsten and bismuth.

Specific examples include calcium acetate, calcium chloride, calcium formate, calcium sulfate, barium acetate, barium sulfate, barium phosphate, manganese chloride, manganese acetate, manganese formate dihydrate, ammonium manganese sulfate hexahydrate, cupric chloride, ammonium chloride copper (II) dihydrate, copper sulfate, cobalt chloride, cobalt thiocyanate, cobalt sulfate, nickel sulfate hexahydrate, nickel chloride hexahydrate, nickel acetate tetrahydrate, ammonium nickel sulfate hexahydrate, nickel amidosulfate tetrahydrate, aluminum sulfate, aluminum alum, basic poly aluminum hydroxide, aluminum sulfite, aluminum thiosulfate, aluminum polychloride, aluminum nitrate enneahydrate, aluminum chloride hexahydrate, ferrous bromide, ferrous chloride, ferric chloride, ferrous sulfate, ferric sulfate, zinc phenolsulfonate octahydrate, zinc bromide, zinc chloride, zinc nitrate hexahydrate, zinc sulfate, zinc acetate ammonium, zinc ammonium carbonate, titanium tetrachloride, tetra isopropyl titanate, titanium acetylacetonate, titanium lactate, chromium acetate, chromic sulfate, magnesium sulfate, magnesium chloride hexahydrate, magnesium citrate enneahydrate, phosphorus sodium tungstate, tungsten sodium citrate, 12 tungst phosphate n hydrate, 12 tungst silicate 26 hydrate, molybdenum chloride, 12 molybden phosphaten hydrate, gallium nitrate, germanium nitrate, strontium nitrate, yttrium acetate, yttrium chloride, yttrium nitrate, indium nitrate, lanthanum nitrate, lanthanum chloride, lanthanum acetate, lanthanum benzoate, cerous chloride, cerium sulfate, cerium octylate, praseodymium nitrate, neodymium nitrate, samarium nitrate, europium nitrate, gadolinium nitrate, dysprosium nitrate, erbium nitrate, ytterbium nitrate, hafnium chloride, bismuth nitrate.

Other Components

In addition, the ink receiving layer contains the following components if necessary.

To restrain the deterioration of the colorant, a discoloring prevention agent such as various ultraviolet absorbers, surface-active agents, antioxidants and singlet oxygen quencher may be preferably contained.

Examples of the ultraviolet absorbers include cinnamic acid derivative, benzophenone derivative and benzotriazolyl phenol derivative. Specific examples include o(-cyano-phenyl innamic acid butyl, o-benzotriazole phenol, o-benzotriazole-p-chlorophenol, o-benzotriazole-2,4-di-t-butyl phenol, o-benzotriazole-2,4-di-t-octyl phenol. A hindered phenol compound can be also used as an ultraviolet absorber, and phenols in which at least one or more of the second place and the sixth place is substituted by a diverging alkyl group is preferable.

A benzotriazole based ultraviolet absorber, a salicylic acid based ultraviolet absorber, a cyano acrylate based ultraviolet absorber, and oxalic acid anilide based ultraviolet absorber or the like can be also used. For instance, the ultraviolet absorbers are described in JP-A Nos. 47-10537, 58-111942, 58-212844, 59-19945, 59-46646, 59-109055 and 63-53544, Japanese Patent Application Publication (JP-B) Nos. 36-10466, 42-26187, 48-30492, 48-31255, 48-41572 and 48-54965, 50-10726, U.S. Pat. Nos. 2,719,086, 3,707,375, 3,754,919 and 4,220,711 or the like.

A fluorescent whitening agent can be also used as an ultraviolet absorber, and specific examples include a coumalin based fluorescent whitening agent. Specific examples are described in JP-B Nos. 45-4699 and 54-5324 or the like.

A cation based, an anion based, a nonion based, an amphoteric, a fluorine based, and a silicon based surface-active agents can be used as a surface-active agent. The surface-active agents may be used singly or in combination.

Examples of the nonion based surface-active agents include polyoxyalkylenealkylether and polyoxyalkylenealkylphenylethers (for instance, diethylene glycol monoethyl ether, diethylene glycoldiethyl ether, polyoxy ethylene laurylether, polyoxy ethylene stearylether, polyoxy ethylene nonylphenyl ether or the like), oxyethylene oxypropylene blockcopolymer, sorbitan fatty acid esters (for instance, sorbitan mono laurate, sorbitan monoorate, sorbitan triorate or the like), polyoxethylene sorbitan fatty acid esters (for instance, polyoxyethylene sorbitan mono laurate, polyoxyethylene sorbitan monoorate, polyoxyethylene sorbitan mono triorate or the like), polyoxyethylenesorbitol fatty acid esters (for instance, polyoxyethylene sorbit tetraoleate or the like), glycerin fatty acid esters (for instance, glycerol mono orate or the like), polyoxyethylene glycerin fatty acid esters (monostearate polyoxyethylene glycerin, monooleate polyoxyethylene glycerin or the like), polyoxyethylene fatty acid esters(polyethylene glycol mono laurate, polyethylene glycol monoorate or the like), polyoxyethylene alkylamine, acetylenic glycols (for instance, 2,4,7,9-tetramethyl-5-desine-4,7-diol and ethylene oxide addition of the diol, propylene oxide addition -or the like). Polyoxyalkylene alkylethers are preferable. The nonion based surface-active agent may be contained in the coating liquid for the ink receiving layer.

Examples of the amphoteric surface-active agents include an amino acid type, a carboxy ammonium betaine type, a sulfone ammonium betaine type, an ammonium sulfate betaine type and imidazolium betaine type. For instance, the amphoteric surface-active agents which are described in U.S. Pat. No. 3,843,368, JP-A Nos. 59-49535, 63-236546, 5-303205, 8-262742 and 10-282619 or the like can be preferably used. An amino acid type amphoteric surface-active agent is preferable as the amphoteric surface-active agent. The amino acid type amphoteric surface-active agent is derivatized from an amino acid (glycine, glutamic acid, and histidine acid or the like) as described in JP-A No. 5-303205. Examples of the amino acid type amphoteric surface-active agents include N-amino acyl acid in which a long-chain acyl group is introduced and its salt.

Examples of the anion based surface-active agents include a fatty acid salt (for instance, sodium stearate and potassium oleate), an alkyl sulfate ester salt (for instance, sodium lauryl sulfate, triethanol amine lauryl sulfate), a sulfonate (for instance, sodium dodecylbenzenesulfonate), an alkylsulfo succinic acid salt (for instance, dioctylsulfo sodium succinate), alkyldiphenylether disulfonate and alkyl phosphate. Examples of the cation based surface-active agents include alkyl amine salt, a quaternary ammonium salt, a pyridinium salt, an imidazolium salt.

Examples of the fluorine based surface-active agents include compounds derivatized through the intermediate having parfluoro alkyl group by using a method such as an electrolysis fluorination, telomerization and oligomerization. Examples include parfluoro alkyl sulfonate, parfluoro alkylcarboxylate, parfluoro alkylethyleneoxide additament, parfluoro alkyl trialkyl ammonium salt, parfluoro alkyl group-containing oligomer, and parfluoro alkyl phosphate ester or the like.

A silicon oil modified by an organic group is preferable as the silicon based surface-active agent, and has the structure in which the side chain of the siloxane structure is modified by the organic group, the structure in which both terminals are modified, and the structure in which a terminal is modified. Examples of the organic group modification include amino modification, polyether modification, epoxy modification and carboxylic modification, carbinol modification, alkyl modification, aralkyl modification, phenol modification, and fluorine modification.

The content of the surface-active agent contained in the coating liquid for the ink receiving layer is preferably 0.001 to 2.0%, more preferably 0.01 to 1.0%.

Examples of the antioxidants are described in EP 223739, 309401, 309402, 310551, 310552 and 459416, D.E. Patent No. 3435443, JP-A Nos. 54-48535, 60-107384, 60-107383, 60-125470, 60-125471, 60-125472, 60-287485, 60-287486, 60-287487, 60-287488, 61-160287, 61-185483, 61-211079, 62-146678, 62-146680, 62-146679, 62-282885, 62-262047, 63-051174, 63-89877, 63-88380, 66-88381, 63-113536, 63-163351, 63-203372, 63-224989, 63-251282, 63-267594, 63-182484, 1-239282, 2-262654, 2-71262, 3-121449, 4-291685,4-291684, 5-61166, 5-119449, 5-188687, 5-188686, 5-110490, 5-1108437 and 5-170361, JP-B Nos. 48-43295 and 48-33212, U.S. Pat. Nos. 4,814,262 and 4,980,275.

Specific examples of the antioxidants include 6-ethoxy-1-phenyl-2,2,4-trimethy-1,2-dihydroquinoline, 6-ethoxy-1-octyl-2,2,4-trimethyl-1,2-dihydroquinoline, 6-ethoxy-1-phenyl-2,2,4-trimethy-1,2,3,4-tetrahydroquinoline, 6-ethoxy-1-octyl-2,2,4-trimethyl-1,2,3,4,-tetrahydroquinoline, nickel cyclohexanoate, 2,2-bis(4-hydroxyphenyl)propane, 1,1-bis(4-hydroxyphenyl)-2-ethylhexane, 2-methy-4-methoxy-diphenylamine, 1-methyl-2-phenyl indole.

The discolorating prevention agents may be also used singly or in combination. The discolorating prevention agent may be water soluble, dispersed and emulsion, and can be contained in a microcapsule. The amount of addition of the discolorating prevention agent is preferably 0.01 to 10% by mass of the coating liquid for the ink receiving layer.

The ink receiving layer may contain various inorganic salts, acid and alkali as a pH adjuster to improve the dispersing property of inorganic particles. Further, the ink receiving layer may contain metal oxide fine particles having electroconductivity to suppress the friction electrification and peeling electrification of the surface, and various mat agents to reduce the friction property of the surface.

It is preferable that the pH of the surface of the ink receiving layer formed is in the range of 3 to 6. When the pH of the surface is in the above-mentioned range, yellow discoloration can be effectively suppressed. The pH of the surface of the layer can be measured by using a pH measuring set type MPC for paper surface manufactured by KYORITSU CHEMICAL-CHECK Lab., Corp.

After an aqueous solution of 2% vanillin has been dropped onto the ink receiving layer and the ink receiving layer has been left for 24 hours, the yellow density (reflection density) of the ink receiving layer at a portion where the aqueous solution has been dropped is preferably 0.05 or less. On such an ink receiving layer, it is possible to form an image which is excellent in ground whiteness, is vivid and clear, and has high contrast. Herein, the yellow density can be measured with a blue (B) filter by using a reflection densitometer (trade name: X-rite938, manufactured by X-rite Incorporated.).

### EXAMPLES

Hereinbelow, the present invention will be described by way of the following examples. However, the examples should not be construed to limit the scope of the invention. A sheet for ink jet recording is prepared as one example of the ink jet recording medium in the Examples. In the Examples, the term “part” and the term “%” represent part by mass and % by mass, respectively, when not indicated specifically.

### Example 1

Preparation of Support

Wood pulp made of LBKP was adjusted to canadian freeness of 300 ml by a disk refiner. Next, to the pulp slurry, cationic starch (trade name: CATO 304L, produced by Nippon NSC, Ltd.) of 1.3%, anionic polyacrylamide (trade name: Polyakron ST-13, produced by SEIKO PMC CORPORATION) of 0.145%, alkylketenedimer (trade name: Sizepine K, produced by Arakawa chemical Industries, Ltd.) of 0.285%, epoxidized amide behenate of 0.285%, and polyamide polyamine epichlorohydrin (trade name: Arafix 100, produced by Arakawa Chemical Industries, Ltd.) were added. A defoaming agent was then added to the resultant mixture.

The pulp slurry prepared as described above was prepared by a making paper machine, and the photograph emulsion coating surface of a web was in contact with a drum drier cylinder through a drier canvas. After being dried, polyvinyl alcohol (trade name: KL-118, produced by Kuraray Co., Ltd.) of 1 g/m² was coated on both surfaces of a base paper by a size press, and dried. A calender treatment was then performed to obtain a base paper sheet. The basis weight of the base paper was 166 g/m², and the thickness of the base paper sheet was 160 μm.

A corona electrical discharge treatment was applied to the wire surface (back) of the base paper sheet obtained. High-density polyethylene with thickness of 25 μm was coated by using a melt extrusion machine to form a resin layer made of a mat surface (hereinafter, the surface of the resin layer is referred to as “back”). The corona electrical discharge treatment was further applied to the resin layer formed on the back. Then, a dispersed solution obtained by dispersing aluminum oxide (trade name: “Alumina sol 100”, produced by Nissan Chemical Industries, Ltd.) and colloidal silicon dioxide (“Snowtex O”, produced by Nissan Chemical Industries, Ltd.) in water such that the mass ratio of the aluminum oxide to the colloidal silicon dioxide is 1:2 was coated as a back coating solution. The dispersed solution was coated such that the drying mass is 0.2 g/m².

The corona electrical discharge treatment was further applied to a felt surface (surface) on which no resin layer was formed. Then, anatase type titanium dioxide of 10% and permanent blue produced by Tokyo Ink CO., Ltd. was adjusted to the content of 60 mg/m². Low-density polyethylene of MFR (melt flow rate) 3.8 in which a fluorescent whitening agent (trade name: White flour PSN conc) produced by Nippon chemical Industries Co., Ltd was prepared to the content of 13 mg/m²was extruded by using a melt extrusion machine such that the thickness was 20 μm. A thermoplastic resin layer having high glossiness was formed on the surface of the base paper sheet (hereinafter, the high glossiness surface is referred to as “right surface”) to form a support.

Preparation of coating liquid (first liquid) A for ink receiving layer (1) fumed silica particles, (2) ion-exchange water and (3) Chemistat 7005 of the following composition were mixed. After the resultant mixture was stirred at 9000 rpm for 30 minutes by a dissolver produced by Tokushu Kika Kogyo Co., Ltd., a silica dispersion liquid was prepared by using a sand mill type disperser (trade name: KD-P, manufactured by Shinmaru Enterprises Corporation). An aqueous solution in which (4) boric acid was dissolved in (5) ion-exchange water was then added to the silica dispersed liquid, and the resultant mixture was stirred at 8000 rpm for 20 minutes by a dissolver manufactured by Tokushu Kika Kogyo Co., Ltd. To the mixture, (6) polyvinyl alcohol, (7) polyoxyethylene lalury ether and (8) fluorine based surface-active agent were further added, and the resultant mixture was stirred at 2000 rpm for 20 minutes to prepare a coating liquid A (pH 3.5) for an ink receiving layer.

(Composition of coating liquid A for ink receiving layer)

| | |
|---|---|
| (1) Fumed silica particles (trade name: Aerosil 300, produced | 8.9 parts |
| by Nihon Aerosil Co., Ltd., average primary particle | |
| diameter: 7 nm, specific surface area: 300 m²/g) | |
| (2) Ion-exchange water | 49.7 parts |
| (3) trade name: Chemistat 7005 (40.5% aqueous solution) | 1.1 parts |
| (produced by Sanyo Chemical Industries, Ltd.; cationic | |
| polymer) | |
| (4) Boric acid (cross-linking agent) | 0.4 parts |
| (5) Ion-exchange water | 10 parts |
| (6) 7% aqueous solution containing polyvinyl alcohol (water- | 28.2 parts |
| soluble resin) (trade name: PVA-124, produced by | |
| Kuraray Co., Ltd., saponification degree: 98.5%, | |
| polymerization degree: 2400) | |
| (7) Polyoxyethylene lauryl ether (surface-active agent) (trade | 1.2 parts |
| name: Emulgen 109P (10% aqueous solution), produced | |
| by Kao Corporation, HLB value: 13.6) | |
| (8) Fluorine based surface-active agent (10% aqueous | 0.5 parts |
| solution) (trade name: Megaface F1405, produced by | |
| Dainippon Ink And Chemicals, Incorporated) | |

Preparation of Basic Solution (Second Liquid) B

Next, components of the following composition were mixed to prepare a basic solution B (pH 7.9).

<Composition of basic solution B>

| | |
|---|---|
| Boric acid (cross-linking agent) | 0.65 parts |
| Ammonium zirconium carbonate (zirconium oxide 13% | 15.4 parts |
| solution) | |
| Ion-exchange water | 69.95 parts |
| Ammonium carbonate (Primary; produced by Kanto | 2 parts |
| Kagaku) | |
| Polyoxyethylene lauryl ether (surface-active agent) (trade | 10 parts |
| name: Emulgen 109P (2% aqueous solution), produced by | |
| Kao Corporation, HLB value: 13.6) | |
| Fluorine based surface-active agent (10% aqueous | 2 parts |
| solution) (trade name: Megaface F1405, produced by | |
| Dainippon Ink And Chemicals, Incorporated) | |

Preparation of Sheet for Ink Jet Recording

After the corona electrical discharge treatment was applied to the right surface of the support obtained as described above, the coating liquid A for the ink receiving layer was coated on the right surface by using extrusion die coater in the coating amount of 175 ml/m² (coating step). The support was dried at 80° C. (wind velocity: 3 to 8 m/sec) in a hot air dryer such that the solids of the coating became 20%. The coating layer showed constant-rate of drying for the period. Immediately, the support was soaked in the basic solution B for 30 seconds, and the basic solution B of 15 g/m² was adhered on the coating layer. The coating layer was then dried at 80° C. for 10 minutes (hardening step). Therefore, a sheet (1) for ink jet recording of the invention in which the ink receiving layer having a drying film thickness of 35 μm was formed was obtained. The surface of the ink receiving layer had a pH of 4.1.

### Example 2

The support was prepared in the same manner as in Example 1, and a sheet (2) for ink jet recording of the invention was prepared as follows.

-Preparation of Coating Liquid (First Liquid) C for Ink Receiving Layer-

First, (1) silica fine particles prepared by a gas phase method, (2) ion exchange water, (3) “Shallot DC-902P” and (4) “ZA-30” of the following composition were mixed. After the resultant mixture was stirred at 9000 rpm for 30 minutes by dissolver (manufactured by Tokushu Kika Kogyo Co., Ltd.), the mixture was dispersed by using a sand mill type disperser (trade name: KD-P, manufactured by Shinmaru Enterprises Corporation). The dispersing liquid obtained was then heated at 45° C. for 20 hours. Then, (5) boric acid, (6) polyvinyl alcohol dissolved liquid, (7) “Superflex 600B”, (8) polyoxyethylene lauryl ether and (9) ethanol were added to the mixture at 30° C., and a coating liquid C (pH 3.9) for an ink receiving layer of the invention was prepared.

<Composition of coating liquid C for ink receiving layer>

| | | |
|---|---|---|
| (1) | Silica fine particles prepared by gas phase method (fine | 10.0 parts |
| | inorganic particles) (trade name: AEROSIL300SF75, | |
| | manufactured by Nippon Aerosil Co., Ltd.) | |
| (2) | Ion exchange water | 64.8 parts |
| (3) | Shallol DC902P (51.5% water solution) (Dispersing | 0.87 part |
| | agent, manufactured by Dai-ichi Kogyo Seiyaku Co., | |
| | Ltd.) | |
| (4) | ZA-30 (trade name, manufactured by DAIICHI | 0.54 part |
| | KIGENSO KAGAKU KOGYO CO., LTD.; acetyl | |
| | zirconium) | |
| (5) | Boric acid (cross-linking agent) | 0.37 part |
| (6) | Polyvinyl alcohol (water-soluble resin) dissolved liquid | 29.4 parts |
| | Composition | |
| | PVA-235 (saponification degree: 88%, | 2.03 parts |
| | polymerization degree: 3500, | |
| | manufactured by Kuraray Co., Ltd.) | |
| | Polyoxyethylene lauryl ether (surfactant) | 0.03 part |
| | Compound represented by the following | 0.06 part |
| | formula (1) | |
| | Diethylene glycol monobutyl ether (trade | 0.68 part |
| | name: Butysenol 20P, manufactured by | |
| | KYOWA HAKKO KOGYO Co., Ltd.) | |
| | Ion exchange water | 26.6 parts |
| (7) | Superflex 600B (trade name, manufactured by Dai-ichi | 1.24 parts |
| | Kogyo Seiyaku Co., Ltd.) | |
| (8) | Polyoxyethylene lauryl ether (surfactant) (Emulgen 109P | 0.49 part |
| | (10% water solution), manufactured by Kao Corporation, | |
| | HLB value: 13.6) | |
| (9) | Ethanol | 2.49 parts |

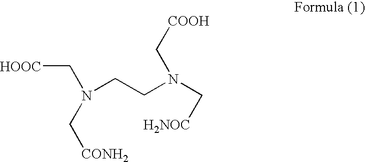

After the corona electrical discharge treatment was applied to the right surface of the support obtained as described above, the coating liquid C for the ink receiving layer was flown in the coating amount of 173 ml/m², and a ⅕ diluted polychlorinated aluminum water solution [Alphain 83 (trade name, manufactured by TAIMEI Chemicals Co., Ltd.) was used for polychlorinated aluminum.] was flown at the speed of 10.8 ml/m² and inline blended. The water solution was then coated by using an extrusion die coater (coating step). The coating layer was then dried at 80° C. (wind velocity: 3 to 8 m/sec) in a hot air dryer until the solid content of the coating layer of 20% was obtained. The coating layer showed constant-rate of drying for the period. Before the coating layer exhibits a decreasing rate of drying, the coating layer was soaked in the following basic solution D for 3 seconds, and thereby the basic solution D of 13 g/m² was adhered on the coating layer. The coating layer was then dried at 80° C. for 10 minutes (curing step). Thus, a sheet (2) for ink jet recording of the invention in which the ink receiving layer having a drying film thickness of 35 μm was formed was obtained. The pH of the surface of the ink receiving layer was 4.1.

-Preparation of Basic Solution (Second Liquid) D-

The following components were mixed to prepare a basic solution D (pH 8.0).

<Composition of basic solution D>

| | |
|---|---|
| Boric acid (cross-linking agent) | 0.65 part |
| Ammonium zirconium carbonate (trade name: Zircosol | 2.5 parts |
| AC-7 (28% water solution), manufactured by DAIICHI | |
| KIGENSO KAGAKU KOGYO CO., LTD.) | |
| Ammonium carbonate (Primary; manufactured by Kanto | 3.5 parts |
| Kagaku) | |
| Ion exchange water | 63.3 parts |
| Polyoxyethylene lauryl ether (surfactant) (trade name: | 30.0 parts |
| Emulgen 109P (2% water solution), manufactured by Kao | |
| Corporation, HLB value: 13.6) | |

### Example 3

A sheet (3) for ink jet recording was obtained in the same manner as in Example 2 except for the ammonium carbonate contained in the basic solution D was replaced by ammonium hydrogencarbonate so as to prepare a basic solution E (pH 7.8) in “Preparation of basic solution D” of Example 2. The pH of the surface of the ink receiving layer was 4.1.

### Example 4

A sheet (4) for ink jet recording was obtained in the same manner as in Example 2 except for preparing a basic solution F (pH 7.7) having the following composition in place of the basic solution D in Example 2. The pH of the surface of the ink receiving layer was 4.1.

<Composition of basic solution F>

| | |
|---|---|
| Boric acid (cross-linking agent) | 0.65 part |
| Ammonium zirconium carbonate (Zircosol AC-7 (28% | 1.5 parts |
| water solution), trade name, manufactured by DAIICHI | |
| KIGENSO KAGAKU KOGYO CO., LTD.) | |
| Ammonium carbonate (Primary; manufactured by Kanto | 3.5 parts |
| Kagaku) | |
| Ion-exchange water | 64.3 parts |
| Polyoxyethylene lauryl ether (surfactant) (trade name: | 30.0 parts |
| Emulgen 109P (2% water solution), manufactured by Kao | |
| Corporation, HLB value: 13.6) | |

### Comparative Example 1

A sheet (5) for ink jet recording of Comparative Example 1 was obtained in the same manner as in Example 1 except for replacing the basic solution B of Example 1 by a basic solution G, which was prepared by mixing the following compositions.

<Composition of basic solution G>

| | |
|---|---|
| Boric acid (cross-linking agent) | 0.65 parts |
| 20% aqueous solution containing polyallylamine (trade | 15 parts |
| name: PAA-03, produced by Nittobo; mordant) | |
| Ion-exchange water | 72.35 parts |
| Polyoxyethylene lauryl ether (surface-active agent) (trade | 10 parts |
| name: Emulgen 109P (2% aqueous solution), produced by | |
| Kao Corporation, HLB value: 13.6) | |
| Fluorine based surface active agent (10% aqueous | 2 parts |
| solution) (trade name: Megaface F1405, produced by | |
| Dainippon Ink And Chemicals, Incorporated) | |

### Comparative Example 2

A sheet (6) for ink jet recording of Comparative Example 2 was obtained in the same manner as in Example 1 except for replacing the basic solution B of Example 1 by a basic solution H, which was prepared by mixing the following compositions.

<Composition of basic solution H>

| | |
|---|---|
| Boric acid (cross-linking agent) | 0.65 parts |
| 20% aqueous solution containing polyallylamine (trade | 15 parts |
| name: PAA-03, produced by Nittobo; mordant) | |
| Ion-exchange water | 71.35 parts |
| Ammonium chloride | 1 part |
| Polyoxyethylene lauryl ether (surface-active agent) (trade | 10 parts |
| name: Emulgen 109P (2% aqueous solution), produced by | |
| Kao Corporation, HLB value: 13.6) | |
| Fluorine based surface active agent(10% aqueous | 2 parts |
| solution) (trade name: Megaface F1405, produced by | |
| Dainippon Ink And Chemicals, Incorporated) | |

### Comparative Example 3

A sheet (7) for ink jet recording of Comparative Example 3 was obtained in the same manner as in Example 1 except for adding no ammonium carbonate in the preparation of the basic solution B of Example 1.

### Comparative Example 4

A sheet (8) for ink jet recording of Comparative Example 4 was obtained in the same manner as in Example 1 except for replacing the basic solution B of Example 1 by a basic solution I, which was prepared by mixing the following compositions.

<Composition of basic solution I>

| | |
|---|---|
| Boric acid (cross-linking agent) | 0.65 parts |
| Polyallylamine 20% aqueous solution (trade name: PAA- | 15 parts |
| 03 produced by Nittobo; mordant) | |
| Ion-exchange water | 69.95 parts |
| Ammonium carbonate (Primary; produced by Kanto | 2 parts |
| Kagaku) | |
| Polyoxyethylene lauryl ether (surface-active agent) (trade | 10 parts |
| name: Emulgen 109P (2% aqueous solution), produced by | |
| Kao Corporation, HLB value: 13.6) | |
| Fluorine based surface active agent (10% aqueous | 2 parts |
| solution) (trade name: Megaface F1405, produced by | |
| Dainippon Ink And Chemicals, Incorporated) | |

### Comparative Example 5

A sheet for ink jet recording of Comparative Example was to be produced in the same manner as in Example 1 except that the coating layer was dried so as to obtain the solid content of 50% after coating the coating liquid A for the ink receiving layer, and the coating layer was soaked in the basic solution B before the coating layer exhibits a decreasing rate of drying in Example 1. However, a craze was caused in the ink receiving layer, and thereby a sheet for ink jet recording could not be obtained.

### Comparative Example 6

A sheet for ink jet recording of Comparative Example was to be produced in the same manner as in Example 4 except for replacing ammonium carbonate contained in the basic solution F by ammonium chloride to prepare a basic solution J in Example 4. However, a craze was caused in the ink receiving layer, and thereby the sheet for ink jet recording could not be obtained.

(Evaluation)

The sheets (1) to (4) for ink jet recording of the invention obtained as described above and sheets (5) to (8) for ink jet recording of Comparative Examples were evaluated as follows. The following table 1 shows the result of the evaluation.

(1) Measurement of Printing Density

The black solid printing was performed on each sheet for ink jet recording by using ink jet printer PM970C (manufactured by Seiko Epson Corporation). The obtained density of black portions was measured by a reflection densitometer (trade name: Xrite 938 manufactured by Xrite Incorporated.).

(2) Evaluation of Yellow Discoloration

(i) Yellow Discoloration Due to Time Elapse

The sheet for ink jet recording was placed in a Mitsubishi file such that each edge of the sheet was protruded to outside by about 1 cm. After being left under 45° C./50% RH for three days, the sheet was left under 23° C./65%RH for three days. The degree of yellow discoloration of the area located outside the file was measured. Then, the degree of yellow discoloration of the area located in the file was compared with that of the area outside the file, and was visually evaluated. The measurement was conducted by using a reflection densitometer (trade name: X-rite938 (blue filter), manufactured by X-rite Incorporated). The sheet in which yellow discoloration was not observed was indicated as “A”. The sheet colored to yellow a little was indicated as “B”, and the sheet with large degree of the yellow discoloration was indicated as “C”.

(ii) Vanillin Yellow Discoloration

A 2% aqueous solution of vanillin included in a corrugated cardboard or the like was prepared. The aqueous solution of 1 ml was dropped on the ink receiving layer of each sheet for ink jet recording. The degree of yellow coloring at the portions where the aqueous solution was dropped after being left for 24 hours was measured by using a reflection densitometer (trade name: X-rite938 (blue filter), manufactured by X-rite Incorporated).

(3) Evaluation of Beading and Bronzing

The blue solid printing was performed on each sheet for ink jet recording by using ink jet printer PM970C (manufactured by Seiko Epson Corporation). The degree of beading and bronzing after being left for one day was visually evaluated. The sheet in which beading and bronzing was not observed was indicated as “AA” and the sheet in which little beading and bronzing was observed was indicated as “A”. The sheet in which a little beading and bronzing occurred within a practically permissible range was indicated as “B”, and the sheet with large degree of the beading and bronzing was indicated as “C”.

(4) Evaluation of Concentration Distribution of Zirconium Compound

The ink receiving layer of each sheet for ink jet recording was bisected along a section parallel to the support by Microtome (trade name, manufactured by Leica Microsystems Japan). The ratio C¹/C², wherein C¹ represents the zirconium element concentration in a support-side half (a half apart from the support) of the ink receiving layer, which is one half obtained by bisecting the ink receiving layer, and C² represents the zirconium element concentration in a non-support-side half (a half near the support) of the ink receiving layer, which is the other half obtained by bisecting the ink receiving layer, was determined by measuring zirconium element imaging strength under the following conditions by using TRIFTII (trade name, manufactured by ULVAC-PHI, INCORPORATED). [Conditions: primary ion: Ga⁺, acceleration voltage: 15 kv, primary ion current: 600 pA and neutralizing gun ON]

(5) pH Measurement of Surface of Ink Receiving Layer

The surface pH of the ink receiving layer of each sheet for ink jet recording was measured by using a pH measuring set for paper surface (type MPC, manufactured by KYORITSU CHEMICAL-CHECK Lab., Corp.).

TABLE 1

| | Concentration | | | | | Yellow discoloration | | | | |
|---|---|---|---|---|---|---|---|---|---|---|
| | distribution of | pH | | | | due to time elapse | | Vanillin | | |
| | Zr compound | First | Second | Layer | Printing | Measured | | yellow | | |
| | (C¹/C² ) | liquid | liquid | surface | density | value | Evaluation | discoloration | Beading | Bronzing |
| Example 1 | 0.11 | 3.5 | 7.9 | 4.1 | 2.43 | 0.01 | A | 0.005 | A | A |
| Example 2 | 0.85 | 3.9 | 8.0 | 4.1 | 2.44 | 0.01 | — | 0.005 | AA | AA |
| Example 3 | 0.90 | 3.9 | 7.8 | 4.1 | 2.42 | 0.01 | — | 0.005 | AA | AA |
| Example 4 | 0.97 | 3.9 | 7.7 | 4.1 | 2.39 | 0.01 | — | 0.005 | AA | AA |
| Comparative | — | 3.5 | 9.5 | 7.4 | 2.42 | 0.44 | C | 0.23 | B | B |
| Example 1 | | | | | | | | | | |
| Comparative | — | 3.5 | 9.5 | 6.6 | 2.40 | 0.32 | B | 0.17 | C | C |
| Example 2 | | | | | | | | | | |
| Comparative | 0.15 | 3.5 | 8.2 | 4.2 | 2.35 | 0.01 | A | 0.005 | C | C |
| Example 3 | | | | | | | | | | |
| Comparative | — | 3.5 | 9.7 | 7.3 | 2.29 | 0.41 | C | 0.19 | C | C |
| Example 4 | | | | | | | | | | |

As shown in the table 1, the sheet of Examples 1 to 4 that included a metal compound and a basic compound had high printing density, and can suppress yellow discoloration, beading and bronzing.

On the other hand, the sheets of Comparative Examples 1 and 2 that used polyallylamine, a conventional primary amine, instead of a metal compound obviously had various inferior performances such as yellow discoloration, though they could obtain printing density to some extent. Moreover, the beading and bronzing increased when an ammonium salt of strong acid was used as in Comparative Example 2. As compared with the Examples, the beading and bronzing were quite noticeable in the sheet of Comparative Example 3 that used no basic compound. In the sheet of Comparative Example 4 that used a conventional primary amine and an ammonium salt of weak acid, an sufficient printing density was not obtained, beading and bronzing were quite noticeable, and yellow discoloration also occurred.

1. A method for producing an ink jet recording medium, comprising:
coating a first liquid containing a water-soluble resin and a cross-linking agent to form a coating layer on a support; and
providing a second liquid comprising a metal compound and a basic compound to the coating layer either (1) simultaneously with coating of the first liquid or (2) before the coating layer formed of the first liquid exhibits a decreasing rate of drying during drying of the coating layer such that the coating layer is hardened by cross-linking to form an ink receiving layer on the support.

2. The method of claim 1, wherein the first liquid further comprises inorganic particles.

3. The method of claim 1, wherein the first liquid further comprises a surfactant.

4. The method of claim 1, wherein the metal compound is a-zirconium compound and the basic compound is an ammonium salt of weak acid.

5. The method of claim 1, wherein the water-soluble resin is polyvinyl alcohol.

6. The method of claim 1, wherein the cross-linking agent is a boron compound.

7. The method of claim 1, wherein the first liquid has a pH of 6.0 or less, and the second liquid has a pH of 7.1 or more.

8. The method of claim 2, wherein the inorganic particles comprise fumed silica.

9. The method of claim 8, wherein the fumed silica has a specific surface area of 200 m²/g or more as measured according to the BET method.

10. The method of claim 1, wherein the metal compound is contained in the second liquid in an amount of 0.05 to 5% by mass based on a total mass of the second liquid.

11. The method of claim 1, wherein the basic compound is contained in the second liquid in an amount of 0.5 to 10% by mass based on a total mass of the second liquid.

12. The method of claim 4, wherein the zirconium compound comprises ammonium zirconium carbonate.

13. The method of claim 4, wherein the ammonium salt of the weak acid comprises at least one of ammonium carbonate, ammonium hydrogencarbonate and ammonium carbamate.

14. The method of claim 1, wherein the second liquid comprises a cross-linking agent.

15. The method of claim 2, wherein the inorganic particles are dispersed by a cationic resin.

16. The method of claim 2, wherein a ratio of a content of the inorganic particles to a content of the water-soluble resin is 1.5:1 to 10:1.

17. An ink jet recording medium produced by the method of claim 1, wherein a concentration distribution of the metal compound contained in the ink receiving layer is such that a concentration of the metal compound becomes larger towards a direction away form the support in a thickness direction of the ink receiving layer.

18. The ink jet recording medium of claim 17, wherein the concentration distribution of the metal compound satisfies the following formula:
0.8<C¹/C²<1.0
wherein C¹ represents a relative concentration in a support-side half of the ink receiving layer, which is one half obtained by bisecting the ink receiving layer along a section parallel to the support, and C² represents a relative concentration in a non-support-side half of the ink receiving layer, which is the other half obtained by bisecting the ink receiving layer.

19. The ink jet recording medium of claim 17, wherein a surface of the ink receiving layer has a pH of 3 to 6.

20. The ink jet recording medium of claim 17, wherein, after an aqueous solution of 2% vanillin has been dropped onto the ink receiving layer and the ink receiving layer has been left for 24 hours, a yellow reflection density of the ink receiving layer at a portion where the aqueous solution has been dropped is 0.05 or less.
